(19) United States
(12) Patent Application Publication
(10) Pub. No.: US 2003/0156075 A1
(43) Pub. Date: Aug. 21, 2003

(54) Electronic device

(75) Inventors: Hideyuki Motoyama, Kawasaki (JP); Hiroshi Yamada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/252,692

(22) Filed: Sep. 24, 2002

(30) Foreign Application Priority Data
Feb. 15, 2002 (JP) 2002-037732

(51) Int. Cl. G09G 5/00

(52) U.S. Cl. 345/1.3

(57) ABSTRACT

Electronic device in which sound means are provided unitarily with a display panel to serve in miniaturization, and meanwhile in which appropriate acoustic-image orientating in correspondence with swiveling of the display panel is enabled. The electronic device is equipped with panel-status-detection, image-display unit, and sound-control units. The panel-status-detection unit detects whether situational status of the display panel is long-side across or long-side upright. The image-display unit is equipped to have a long-side across display function operating to display images upright with respect to the display panel set long-side across, and a long-side upright display function operating to display images upright with respect to the display panel set long-side upright. Therein, the image-display unit implements either the long-side across display function or the long-side upright display function, based on detection results from the panel-status-detection unit. The sound-control unit causes, based on detection results from the panel-status-detection unit, either the speakers corresponding to the long-side across setting or the speakers corresponding to the long-side upright setting to emit sound.

### BACKGROUND OF THE INVENTION

1. Technical Field

The present invention relates electronic devices furnished with sound means and display means, in particular to electronic devices for playing data such as television programs and movies that includes images and stereo audio.

2. Description of Related Art

Among electronic devices furnished with sound means and display means, miniature electronic devices are in some cases not equipped with a screen-rotation capability, or in some cases are not equipped with a moving-picture play function to accompany stereo audio. Because in such cases screen rotation need not be taken into consideration, controlling the sound image localization stemming from a sound means such as a speaker is not required.

Likewise, in some medium-size electronic devices, the sound means and display means can be rotated independently. In a situation for example in which a display panel for displaying images is rotatably supported and can be situated either long-side across or long-side upright, the speakers might be fixedly disposed independent of the display panel. Because in this case the sound means—i.e., the speakers—is stationary, when switching the display panel rotatively between being long-side across and long-side upright, the sound means does not have to be controlled for sound image localization.

In designing for device miniaturization, making the speakers or like sound means unitary with the display panel or like display means is conceivable, but in that case having the sound means rotate independently is difficult. In most cases the sound means either cannot be controlled, or else is limited to being monophonic.

Recent years have seen the remarkable spread of miniature electronic devices such as web pads, PDAs (personal digital assistants) and handheld computers, and playback high-quality moving picture images have become possible by means of wireless communications and DVDs. Providing a screen rotation capability in miniature electronic devices of this sort to make the display screen pivotable into operation-easing directions is desirable. Nevertheless, in actuality either the speakers or like sound means are independent of the display means, or else are not controlled so as to correspond to the pivoting of the display means.

### SUMMARY OF THE INVENTION

An object of the present invention is to provide an electronic device in which furnishing the sound means unitarily with the display panel serves in its miniaturization, and meanwhile in which appropriate sounds image localization in correspondence with rotation of the display panel is enabled.

An electronic device according to a first aspect of the present invention comprises: an oblong display panel situatable long-side across and long-side upright; a panel-status detection means for detecting whether situational status of the panel is long-side across or long-side upright; image display means; a plurality of speakers corresponding to a long-side across setting; a plurality of speakers corresponding to a long-side upright setting; and sound control means. The image display means is equipped to have a long-side across display function operating to display images upright with respect to the display panel set long-side across, and a long-side upright display function operating to display images upright with respect to the display panel set long-side upright. Therein, based on detection results from the panel-status detection means the image display means implements one of either the long-side across display function or the long-side upright display function. The plurality of speakers corresponding to the long-side across setting is arranged to pair in the left-right direction when the display panel is set long-side across. The plurality of speakers corresponding to the long-side upright setting is arranged to pair in the left-right direction when the display panel is set long-side upright. Based on detection results from the panel-status detection means, the sound control means causes either the speakers corresponding to the long-side across setting or the speakers corresponding to the long-side upright setting to emit sound.

An electronic device in a second aspect of the invention is as set forth in the first aspect, but wherein the speakers corresponding to the long-side across setting and the speakers corresponding to the long-side upright setting are configured as speakers provided in three out of four corner areas of the display panel.

An electronic device in a third aspect is as set forth in the foregoing first and second aspects, but further comprising support means for rotatably supporting the display panel. In this aspect of the invention, furthermore, the panel-status detection means is a tilt sensor for detecting situational status of the display panel by detecting the display panel's gravitational direction based on its rotational position.

In a fourth aspect an electronic device according to the present invention is as set forth in the first and second aspects, but further comprising image-discriminating means for discriminating content of data image-displayed on the display panel. Herein, furthermore, the panel-status detection means determines situational status of the display panel according to discrimination results from the image-discriminating means.

An electronic device in a fifth aspect is as set forth in the foregoing first and second aspects of the present invention, but further comprising image-discriminating means for discriminating content of data image-displayed on the display panel. In this case, furthermore, the image display means implements one of either the long-side across display function and the long-side upright display function, according to discrimination results from the image-discriminating means.

Under a sixth aspect of the present invention, an electronic device comprises an oblong display panel situatable long-side across and long-side upright; image display means; speakers disposed in three out of four corner areas of the display panel; and sound control means. The image display means is equipped to have a long-side across display function operating to display images upright with respect to the display panel set long-side across, and a long-side upright display function operating to display images upright with respect to the display panel set long-side upright. The thus-equipped image display means implements either the long-side across display function or the long-side upright display function. When the image display means implements the long-side across display function, the sound control means causes among all the speakers those speakers that pair in the left-right direction of the display panel, which is set long-side across, to emit sound. When the image display means implements the long-side upright display function, the sound control means causes among all the speakers those speakers pairing in the left-right direction of the display panel, which is set long-side upright, to emit sound.

In a seventh aspect the present invention is an electronic device as set forth in the above-described sixth aspect, but further comprising a display-function selection means for selecting between the long-side across display function and the long-side upright display function.

From the following detailed description in conjunction with the accompanying drawings, the foregoing and other objects, features, aspects and advantages of the present invention will become readily apparent to those skilled in the art.

### BRIEF DESCRIPTION OF THE DRAWINGS

FIG. 1 is a functional block diagram of the configuration of the present invention in a first embodiment;

FIG. 2 is an explanatory diagram illustrating a first state in the first embodiment;

FIG. 3 is an explanatory diagram illustrating a second state;

FIG. 4 is an explanatory diagram illustrating a third state;

FIG. 5 is an explanatory diagram illustrating a fourth state;

FIG. 6 is an explanatory diagram illustrating wiring for the first state;

FIG. 7 is an explanatory diagram illustrating wiring for the second state;

FIG. 8 is an explanatory diagram illustrating wiring for the third state;

FIG. 9 is an explanatory diagram illustrating wiring for the fourth state;

FIG. 10 is an explanatory diagram of an analog switch;

FIG. 11 is an explanatory diagram illustrating wiring utilizing analog switches;

FIGS. 12 through 14 are explanatory diagrams of a tilt sensor;

FIG. 15 is an explanatory diagram of a module wherein a tilt sensor is installed on a speaker;

FIG. 16 is an explanatory diagram of situation in which tilt sensors are installed on a display panel;

FIG. 17 is an explanatory diagram of a first state in a second embodiment;

FIG. 18 is an explanatory diagram of a second state;

FIG. 19 is an explanatory diagram of wiring for the first state; and

FIG. 20 is an explanatory diagram of wiring for the second state.

### DETAILED DESCRIPTION OF THE PREFERRED EMBODIMENTS

Configurational Overview

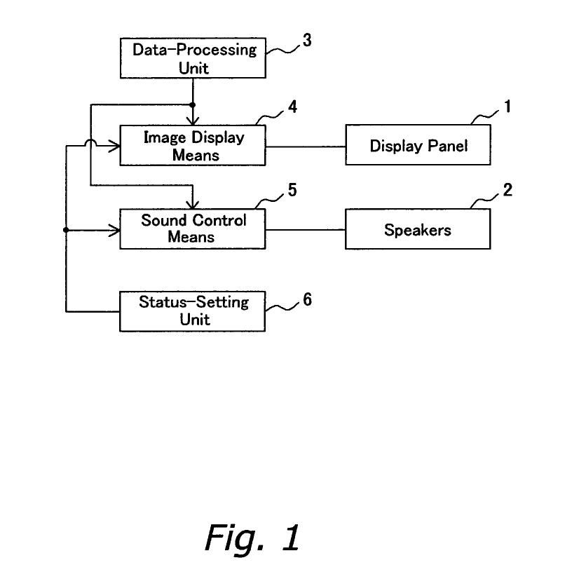

A functional block diagram of an electronic device in which a first embodiment of the present invention is adopted is shown in FIG. 1.

The electronic device is furnished with: a display panel 1, constituted by a liquid-crystal display panel, a plasma display, or other flat-panel display; and a plurality of speakers 2, for localizing the sound image stereophonically.

The display panel 1 and the speakers 2 are built unitarily, and the display panel 1 is rotatably supported so that it will set into either long-side across or long-side upright positions.

The speakers 2 are arranged as: speakers corresponding to a long-side across setting that when the display panel 1 is set long-side across makes them become a pair in the left-right direction; and speakers corresponding to a long-side upright setting that when the display panel 1 is set long-side upright makes them become a pair in the left-right direction.

The device is also furnished with a data processing unit 3 for processing video information obtained via the Internet or other network or wireless communications, or video information read out from a recording medium such as DVDs, CD-ROMs, MOs or hard disks.

The data processing unit 3 is connected to an image display means 4 and a sound control means 5, and via the image display means 4 carries out image display on the display panel 1 and via the sound control means 5 processes sound to the speakers 2.

The image display means 4 generates a drive signal for displaying on the display panel 1 image data sent out from the data processing means 3. The image display means 4 is equipped to have a long-side across display function that works to display images upright with respect to the display panel 1 set long-side across, and a long-side upright display function that works to display images upright with respect to the display panel 1 set long-side upright. In response to information input through a status-setting unit 6 on how the display panel 1 is situated, either the long-side across display function or the long-side upright display function is implemented.

Based on audio data sent out from the data processing unit 3, the sound control means 5 generates a drive signal for causing the speakers 2 to emit sound so as to localize the sound image in the left-right direction stemming from the speakers 2. In response to the information input through a status-setting unit 6 on how the display panel 1 is situated, the sound control means 5 causes either the speakers corresponding to the long-side across setting, or the speakers corresponding to the long-side upright setting to emit sound.

The status-setting unit 6 generates situational status information indicating whether the display panel 1 is situated long-side across or long-side upright, and can be configured for example with tilt sensors, affixed to the display panel 1, that detect gravitational direction, and with a switch for switching between long-side across display and long-side upright display.

First Embodiment

A first embodiment of the present invention will be explained based on the drawings.

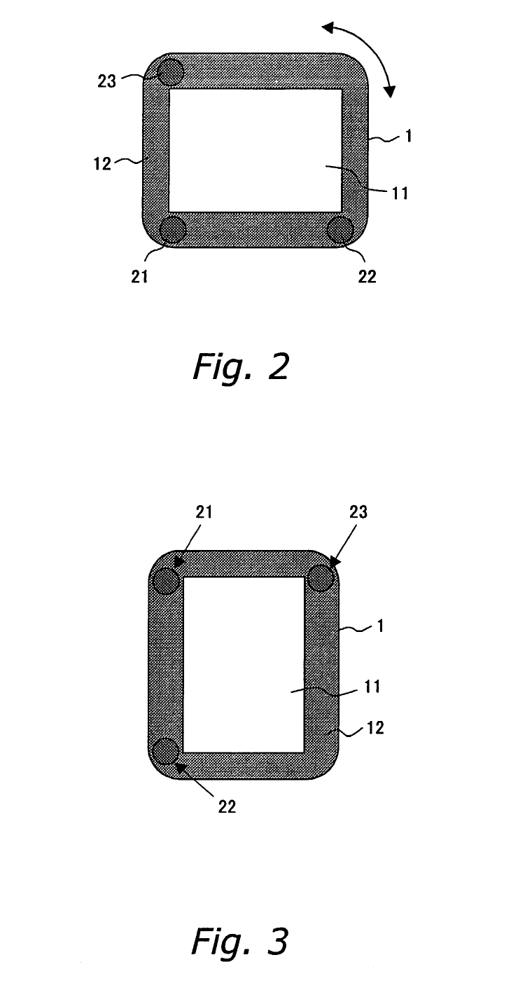

As illustrated in FIG. 2, the display panel 1 is furnished with an oblong display unit 11 constituted by a liquid-crystal panel or like display device. A framing body 12 is formed surrounding the display unit 11, and speakers 21, 22, and 23 that are sound means are provided in three out of the four corner areas. The arrangement of the speakers 21-23 is rendered to dispose them in the corners as separated as possible in order to give forth a stereo feel. Herein, the speaker in the lower left position in FIG. 2, speaker 21, is taken to be the first; the speaker in the lower right position, speaker 22, is taken to be the second; and the speaker in the upper left position, speaker 23, is taken to be the third.

The display panel 1 is supported by a non-illustrated support member that lets it swing, enabling it to swivel in the direction of the arrows in FIG. 2 and rendering it able to assume first through fourth states shown in FIGS. 2 through 5.

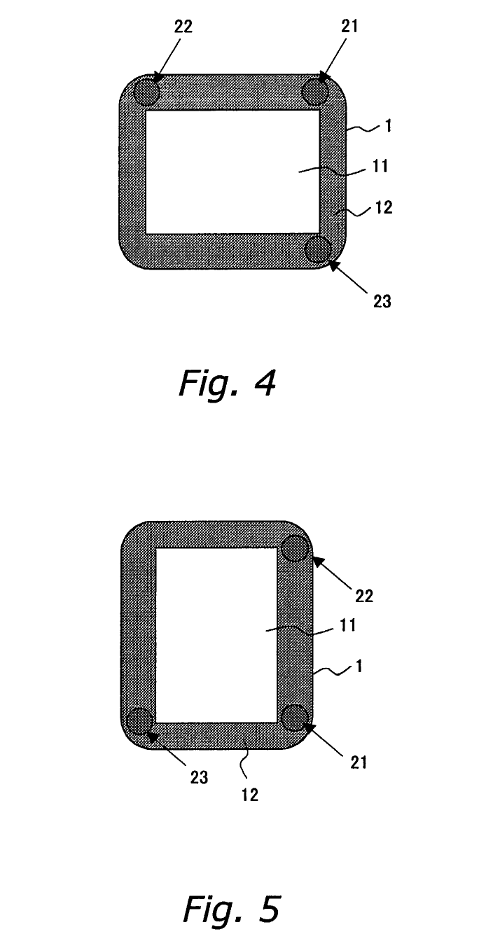

The display panel 1 first state, as shown in FIG. 2, is a state in which the display unit 11 is long-side across, while the first speaker 21 is in the lower left position, the second speaker 22 is in the lower right position, and the third speaker 23 is in the upper left position. The second state, as shown in FIG. 3, is a state in which the display unit 11 is long-side upright, while the first speaker 21 is in the upper left position, the second speaker 22 is in the lower left position, and the third speaker 23 is in the upper right position. The third state, as shown in FIG. 4, is a state in which the display unit 11 is long-side across, while the first speaker 21 is in the upper right position, the second speaker 22 is in the upper left position, and the third speaker 23 is in the lower right position. Furthermore, the fourth state, as shown in FIG. 5, is a state in which the display unit 11 is long-side upright, while the first speaker 21 is in the lower right position, the second speaker 22 is in the upper right position, and the third speaker 23 is in the lower left position.

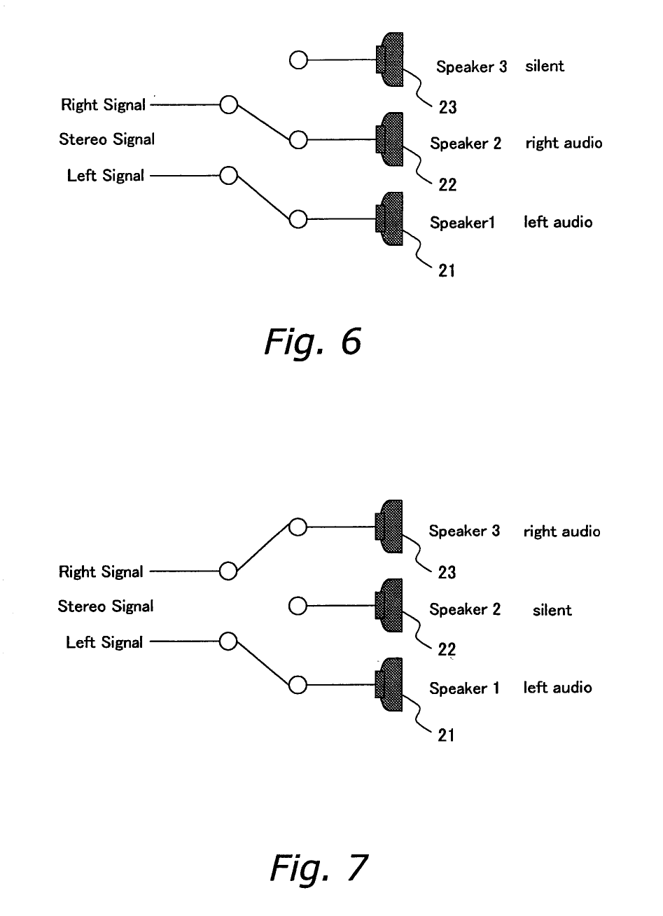

In the first state, the image display means 4 generates an image signal in order that on the display unit 11 in FIG. 2, image data sent out from the data processing unit 3 be displayed as an upright image. Simultaneously, the sound control means 5 causes a stereo signal that is sent out from the data processing unit 3 to emit sound via the first speaker 21 and the second speaker 22. Wiring is arranged as indicated in FIG. 6 such that in this situation, a left audio signal is sounded via the first speaker 21, and a right audio signal is sounded via the second speaker 22.

In the second state, the image display means 4 generates an image signal in order that on the display unit 11 in FIG. 3, image data sent out from the data processing unit 3 be displayed as an upright image. Simultaneously, the sound control means 5 causes a stereo signal that is sent out from the data processing unit 3 to emit sound via the first speaker 21 and the third speaker 23. Wiring is arranged as indicated in FIG. 7 such that in this situation, a left audio signal is sounded via the first speaker 21, and a right audio signal is sounded via the third speaker 23.

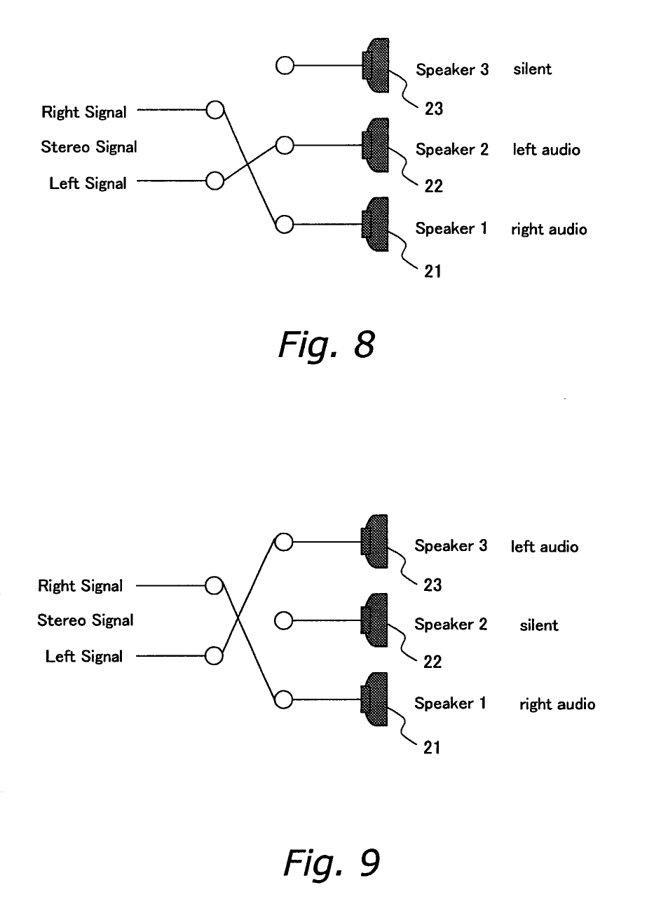

In the third state, the image display means 4 generates an image signal in order that on the display unit 11 in FIG. 4, image data sent out from the data processing unit 3 be displayed as an upright image. Simultaneously, the sound control means 5 causes a stereo signal that is sent out from the data processing unit 3 to emit sound via the first speaker 21 and the second speaker 22. Wiring is arranged as indicated in FIG. 8 such that in this situation, a right audio signal is sounded via the first speaker 21, and a left audio signal is sounded via the second speaker 22.

In the fourth state, the image display means 4 generates an image signal in order that on the display unit 11 in FIG. 5, image data sent out from the data processing unit 3 be displayed as an upright image. Simultaneously, the sound control means 5 causes a stereo signal that is sent out from the data processing unit 3 to emit sound via the first speaker 21 and the third speaker 23. Wiring is arranged as indicated in FIG. 9 such that in this situation, a right audio signal is sounded via the first speaker 21, and a left audio signal is sounded via the third speaker 23.

Rendering the wiring in this way allows the acoustic image from the stereo audio signal to be orientated appropriately regardless of how the display panel 1 is situated, enabling a satisfactory stereo sound to be conveyed to the operator.

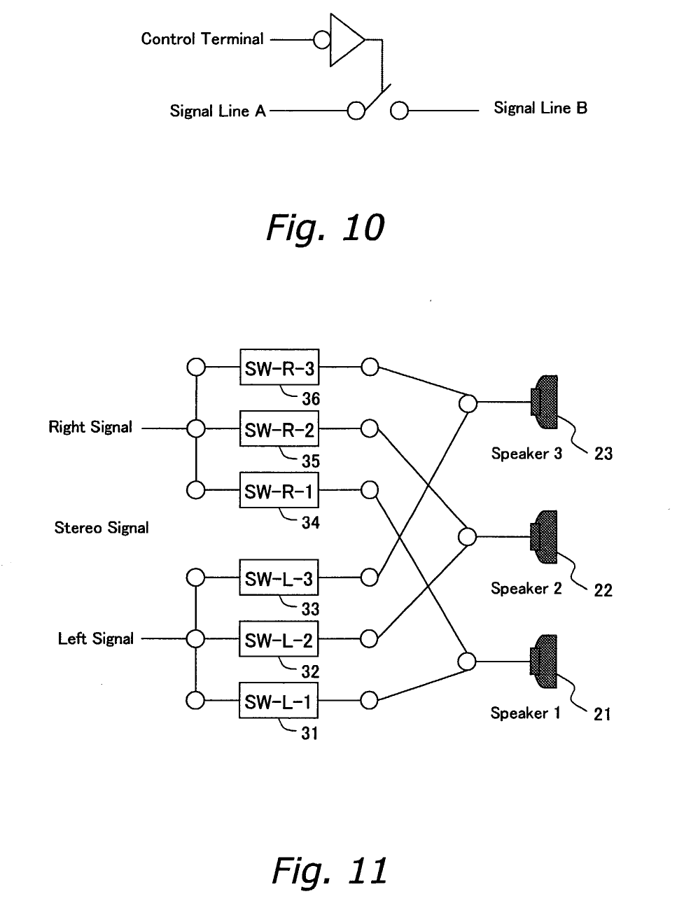

The circuit connections between the left and right audio terminals that send out the stereo audio, and the first through third speakers 21-23 each may, utilizing an analog switch as indicated in FIG. 10, be rendered a respective circuit connection as illustrated in FIG. 11. CMOS analog switches may constitute the analog switches; for example, NJU211s made by New Japan Radio Co. Ltd. may be employed.

In FIG. 11 the wiring is configured such that respective analog switches 31-33 are connected in between left audio-output terminals and the speakers 21-23, and respective analog switches 34 through 36 are connected in between right audio-output terminals and the speakers 21-23.

With the wiring done in this way, when for example the display panel 1 is situated in the first state (see FIG. 2), putting analog switch (SW-L-1) 31 and analog switch (SW-R-2) 35 into the on state, and putting the other analog switches 32,33,34 and 36 into the off state, allows the left audio signal to sound through the first speaker 21, and the right audio signal to sound through the second speaker 22. Settings for the analog switches 31 through 36 in order to make the output with respect to each of the display panel 1's first through fourth situational states appropriately stereophonic are exhibited in Table I.

TABLE I

| | First State | Second State | Third State | Fourth State |
|---|---|---|---|---|
| SW-L-1 | ON | ON | OFF | OFF |
| SW-L-2 | OFF | OFF | ON | OFF |
| SW-L-3 | OFF | OFF | OFF | ON |
| SW-R-1 | OFF | OFF | ON | ON |
| SW-R-2 | ON | OFF | OFF | OFF |
| SW-R-3 | OFF | ON | OFF | OFF |

Control configuration for the analog switches 31 through 36 may be such that, utilizing a general all-purpose control I/O signal line, a control signal is input to the control terminal shown in FIG. 10.

Status Setting Unit

The status-setting unit 6 may be configured so that through software a user may change the situational-state setting for the display panel 1. For example, the status-setting unit 6 may be configured such that the current situational state of the display panel 1 may be selected from among items in a dialog display. Moreover, a switch so that the image-display and audio-output mode may be selected according to the current situational status of the display panel 1 can be furnished.

With the tilt sensors that detect gravitational direction attached to the display panel 1, the configuration may be such that according to detection results from the tilt sensors the situational status of the display panel 1 is sensed and the speakers 21-23 are controlled.

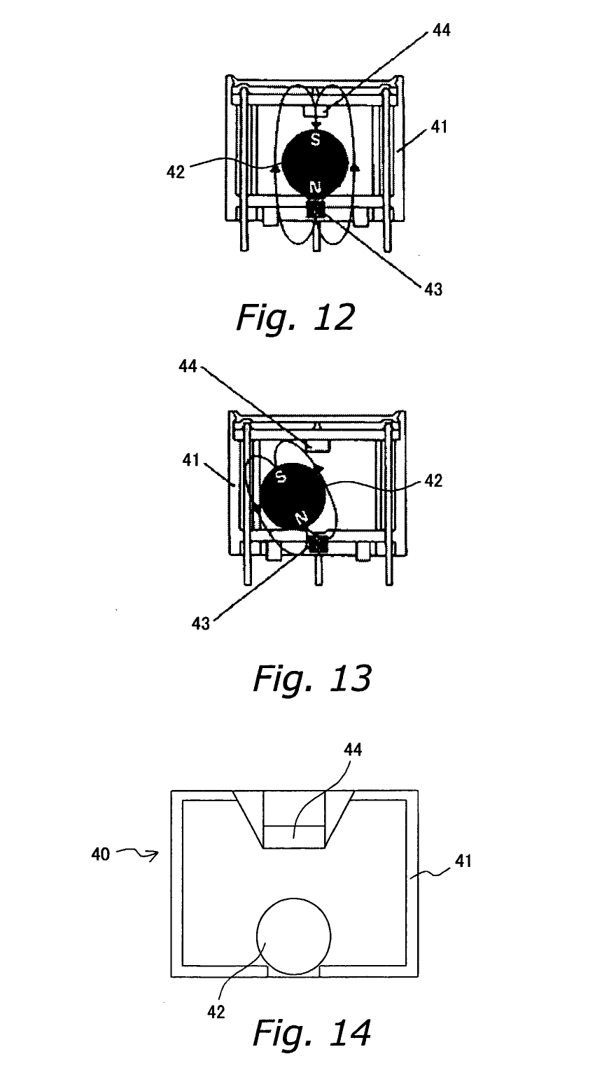

A structure as illustrated in FIGS. 12 and 13 may for example be utilized for a tilt sensor. In this tilt sensor, a magnet 43 and a Hall element 44 are installed on opposing surfaces of a case 41 having a cavity. An iron sphere is nested in the inner cavity of the case 41. Wherein the case 41 maintains a horizontal state, as shown in FIG. 12 the iron sphere 42 positions on a line joining the magnet 43 and Hall element 44. In this situation, the lines of magnetic force from the magnet 43 and the iron sphere 42 will pass through the Hall element 44, which allows the horizontal state of the case 41 to be detected through a detection signal from the Hall element 44. Likewise, as shown in FIG. 13, when the case 41 is tilted, the iron sphere 42 will come off the line joining the magnet 43 and Hall element 44, and the lines of magnetic force passing through the magnet 43 and the iron sphere 42 will no longer pass through the hall element 44. Consequently, whether or not the case 41 is maintaining a given horizontal state may be distinguished based on the detection signal from the Hall element 44.

The speakers employ magnets, and therefore their magnets may also serve a dual-purpose as the tilt sensor magnets. For example, as illustrated in FIG. 14, the Hall element 44 is affixed within the case 41, and the iron sphere 42 is nested within the cavity. The case 41 is installed so that the speaker magnet is located FIG. 14 downward. The interior cavity in the case 41 is configured such that in this state (arrangement in FIG. 14) the iron sphere positions in the center of the interior cavity. Furthermore, the interior cavity in the case 41 is configured so that when the case 41 is tilted, the iron sphere 42 shifts from the center position in the interior cavity in accordance with gravitational force. Likewise, the surface on which the Hall element 44 is installed is formed with the middle jutting into the interior, and so is configured such that if the case 41 is overturned the iron sphere 42 comes to rest in a position off of the center of the interior cavity.

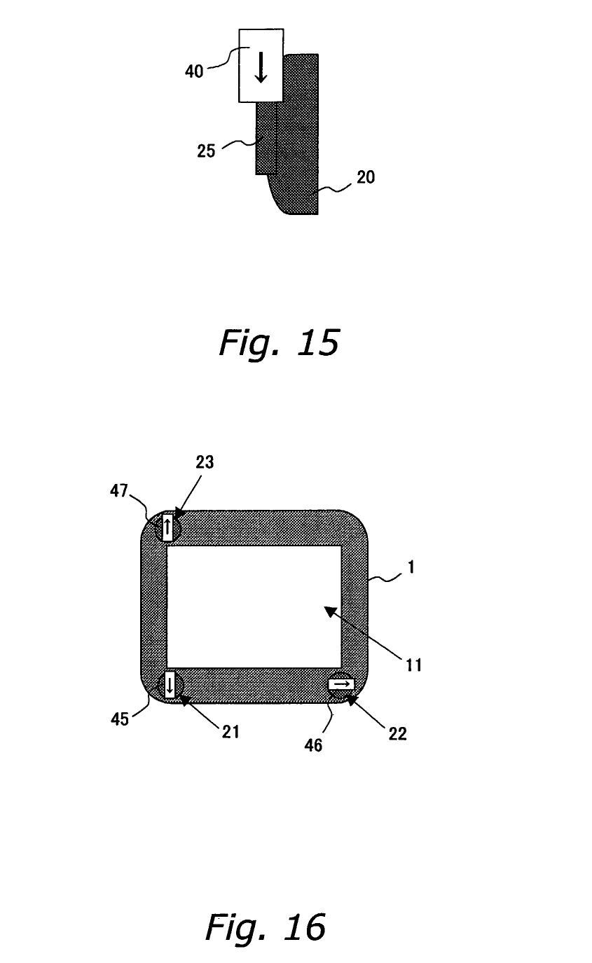

A tilt sensor 40 made in this way is installed adjoining a magnet 25 in a speaker 20 as shown in FIG. 15, and is configured to output a detection signal when gravitational force in the direction of the arrow has been detected, and not to output the detection signal in situations apart from that.

As indicated in FIG. 16, tilt sensors 45 through 47 each having a configuration as described above are installed on respective first through third speakers 21-23 on the display panel 1. First tilt sensor 45 installed on first speaker 21, second tilt sensor 46 installed on second speaker 22, and third tilt sensor 47 installed on third speaker 23 are respectively configured to detect gravitational force in the direction of the arrows shown in FIG. 16. Accordingly, when the display panel 1 is in the first state, shown in FIG. 2, the first tilt sensor 45, installed in the first speaker 21, outputs a detection signal. When the display panel 1 is in the second state, shown in FIG. 3, the second tilt sensor 46, installed in the second speaker 22, outputs a detection signal. And when the display panel 1 is in the third state, shown in FIG. 4, the third tilt sensor 47, installed in the third speaker 23, outputs a detection signal. When the display panel 1 is in the fourth state, shown in FIG. 5, none of the first through third tilt sensors 45-47 outputs a detection signal. This enables the first through fourth states of the display panel 1 to be distinguished therefore based on the output from the first through third tilt sensors 45-47.

The speakers and tilt sensors may each be built as a singular module made of the speaker 20 and tilt sensor 40 as depicted in FIG. 15, and simply altering the direction in which each is mounted enables each of the situational states of the display panel 1 to be detected, and allows manufacturing costs to be curbed.

With regard to switching the image display of the display panel 1 between long-side across and long-side upright, furnishing means that determines the content of the images played enables automatically changing into the state that is the best quality in accordance with the content. With respect to movies and like images that are long-side across, the display thereby may automatically be rendered long-side across, and the configuration may be so as to suggest an appropriate display state to the user. For example, the configuration may be so that if the number of image pixels in the lateral direction is greater than the number of pixels in the lateral direction for the current situational status of the display panel 1, the display state is changed.

Second Embodiment

A second embodiment of the present invention will be explained based on the drawings.

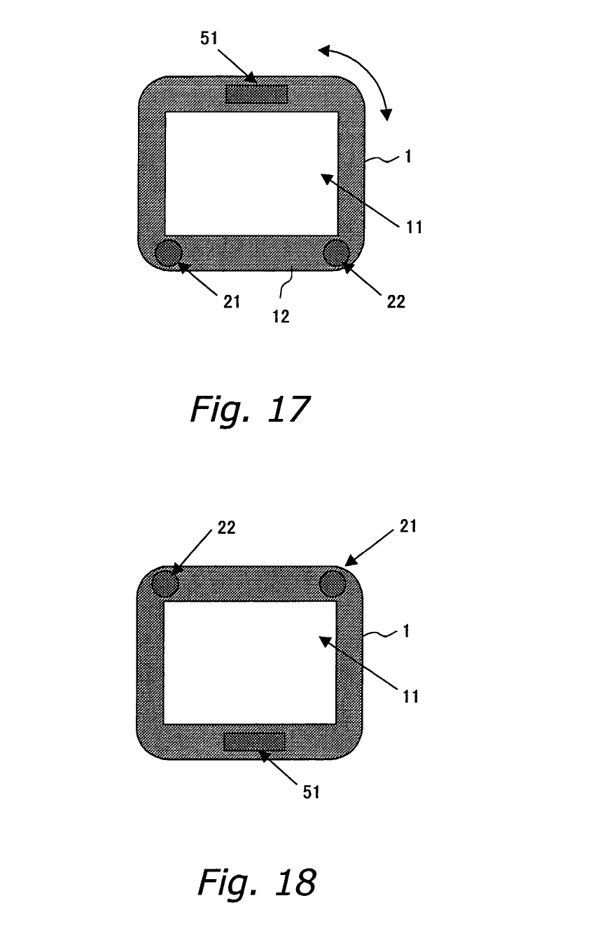

As illustrated in FIG. 17, the display panel 1 is furnished with an oblong display unit 11 constituted by a liquid-crystal panel or like display device. A framing body 12 is formed surrounding the display unit 11, and speakers 21 and 22 that are sound means are provided in two out of the four corner areas. The arrangement of the speakers 21 and 22 is rendered to dispose them in the corners as separated as possible in order to give forth a stereo feel. Herein, the speaker in the lower left position in FIG. 17, speaker 21, is taken to be the first; and the speaker in the lower right position in FIG. 17, speaker 22, is taken to be the second. Further, a camera 51 is installed in the frame body 12 of the display panel 1. The camera 51 enables a picture of an operator's face to be taken, and through the picture acquired by the camera 51, image processing enables the orientation of the operator's face to be distinguished.

The display panel 1 is supported by a non-illustrated support member that lets it swing, enabling it to swivel in the direction of the arrows in FIG. 17 and rendering it able to assume first and second states shown in FIGS. 17 and 18.

The display panel 1 first state, as shown in FIG. 17, is a state in which the first speaker 21 is in the lower left position, and the second speaker 22 is in the lower right position. The second state, as shown in FIG. 18, is a state in which the first speaker 21 is in the upper right position, and the second speaker 22 is in the upper left position.

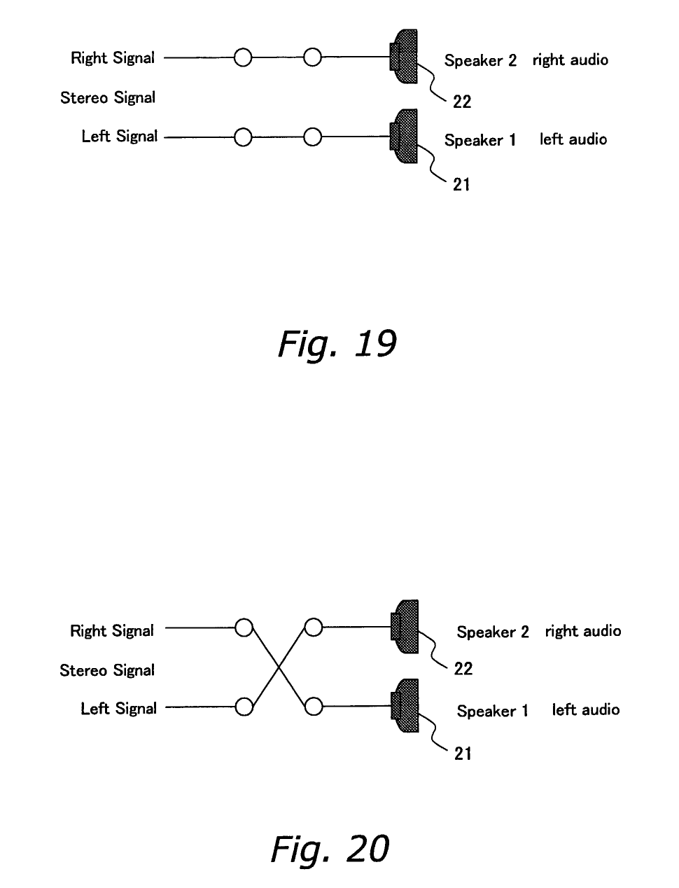

In the first state, the image display means 4 generates an image signal in order that on the display unit 11 in FIG. 17, image data sent out from the data processing unit 3 be displayed as an upright image. Simultaneously, the sound control means 5 controls a stereo signal that is sent out from the data processing unit 3 such that a left audio signal sounds in the first speaker 21, and a right audio signal sounds in the second speaker 22. Here this may be done simply by arranging the wiring as indicated in FIG. 19, such that a left audio signal is sounded via the first speaker 21, and a right audio signal is sounded via the second speaker 22.

In the second state, the image display means 4 generates an image signal in order that on the display unit 11 in FIG. 18, image data sent out from the data processing unit 3 be displayed as an upright image. Simultaneously, the sound control means 5 controls a stereo signal that is sent out from the data processing unit 3 such that a right audio signal sounds in the first speaker 21, and a left audio signal sounds in the second speaker 22. Here this may be done simply by arranging the wiring as indicated in FIG. 20, such that a right audio signal is sounded via the first speaker 21, and a left audio signal is sounded via the second speaker 22.

Likewise as in the mentioned embodiment, this circuit wiring can be realized by utilizing respective analog switches to connect the left and right audio-signal output terminals with the speakers 21 and 22.

The configuration can be such that situational status information pertaining to the how the display panel 1 is situated is selected by an operator keying in the information, or the configuration may be such that the information is set by changing display-driver software configurations. Moreover, it's also possible to choose the situational status information by operation of the switch attached in the display panel 1.

Furthermore, the configuration can be such that how the display panel 1 is situated is discriminated through an operator's facial image acquired by the camera 51, by image-processing to distinguish which way the operator's face is directed.

Other Embodiments

(A) In the first embodiment the electronic device may be configured with a camera installed in the frame body 12 of the display panel 1, such that through images acquired by the camera, how the display panel 1 is situated may detected to control output to the speakers automatically.

(B) In the second embodiment the electronic device may be configured with tilt sensors likewise as in the first embodiment, such that how the display panel 1 is situated may detected.

(C) In the first embodiment, speakers can be provided in the four corner areas of the frame body 12 of the display panel 1.

(D) The speakers can be rendered as a composite in which a number of bass, treble, etc. speakers are combined.

In an electronic device in which a display panel and speakers are constituted integrally, through the present invention, without inviting elevated cost, the stereo feel is not spoiled even when the display panel is swiveled.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

What is claimed is:

1. An electronic device comprising:
an oblong display panel situatable long-side across and long-side upright;
a panel-status detection means for detecting whether situational status of said display panel is long-side across or long-side upright;
an image display means equipped to have a long-side across display function operating to display images upright with respect to said display panel set long-side across, and a long-side upright display function operating to display images upright with respect to said display panel set long-side upright, for implementing one of either the long-side across display function and the long-side upright display function, based on detection results from said panel-status detection means;
a plurality of speakers corresponding to a long-side across setting, arranged to pair in a left-right direction when said display panel is set long-side across;
a plurality of speakers corresponding to a long-side upright setting, arranged to pair in the left-right direction when said display panel is set long-side upright; and
a sound control means for causing, based on detection results from said panel-status detection means, either said speakers corresponding to the long-side across setting or said speakers corresponding to the long-side upright setting to emit sound.

2. An electronic device as set forth in claim 1, wherein said speakers corresponding to the long-side across setting and speakers corresponding to the long-side upright setting are configured as speakers provided in three out of four corner areas of said display panel.

3. An electronic device as set forth in claim 1 or 2, further comprising support means for rotatably supporting said display panel; wherein said panel-status detection means is a tilt sensor for detecting situational status of said display panel by detecting said display panel's gravitational direction based on its rotational position.

4. An electronic device as set forth in claim 1 or 2, further comprising image-discriminating means for discriminating content of data image-displayed on said display panel; wherein said panel-status detection means determines situational status of said display panel according to discrimination results from said image-discriminating means.

5. An electronic device as set forth in claim 1 or 2, further comprising image-discriminating means for discriminating content of data image-displayed on said display panel; wherein said image display means implements one of either the long-side across display function and the long-side upright display function, according to discrimination results from said image-discriminating means.

6. An electronic device comprising:
an oblong display panel situatable long-side across and long-side upright;
an image display means equipped to have a long-side across display function operating to display images upright with respect to said display panel set long-side across, and a long-side upright display function operating to display images upright with respect to said display panel set long-side upright, for implementing one of either the long-side across display function and the long-side upright display function;
speakers disposed in three out of four corner areas of said display panel; and
a sound control means for, when said image display means implements the long-side across display function, causing among said speakers those speakers pairing in a left-right direction of said display panel, wherein it is set long-side across, to emit sound, and for, when said image display means implements the long-side upright display function, causing among said speakers those speakers pairing in the left-right direction of said display panel, wherein it is set long-side upright, to emit sound.

7. An electronic device as set forth in claim 6, further comprising a display-function selection means for selecting between the long-side across display function and the long-side upright display function.
